(19) United States
(12) Patent Application Publication
(10) Pub. No.: US 2013/0067508 A1
(43) Pub. Date: Mar. 14, 2013

(54) CONTROLLING ACCESS OF A USER TO MEDIA CONTENT

(71) Applicant: Onno M. Janssen, Eindhoven (NL)

(72) Inventor: Onno M. Janssen, Eindhoven (NL)

(73) Assignee: KONINKLIJKE PHILIPS ELECTRONICS N.V., EINDHOVEN (NL)

(21) Appl. No.: 13/698,700

(22) PCT Filed: May 18, 2011
(86) PCT No.: PCT/IB11/52174

§ 371 Date: Nov. 19, 2012

(30) Foreign Application Priority Data
May 25, 2010 (EP) 10163746.0

(51) Int. Cl. H04N 21/00

(52) U.S. Cl. 725/30

(57) ABSTRACT

Media device (100) for controlling access of a user to media content, the media device comprising an identification code output (102, 103) arranged for providing an identification code to the user, the identification code identifying the media device, a control code generator (104) arranged for generating a control code in dependence on the identification code and an access right, an access code input (106, 107) arranged for receiving an access code from the user, the access code having been generated in dependence on the identification code and the access right, and an access controller (108) arranged for comparing the access code to the control code, and when the access code matches the control code, granting the user access to the media content in accordance with the access right.

### FIELD OF THE INVENTION

The invention relates to a media device, a method and a system for controlling access of a user to media content. The invention further relates to a computer program product comprising instructions for causing a processor system to perform said method.

### BACKGROUND OF THE INVENTION

Consumers nowadays have many media devices at their disposal that allow access to a wide variety of media content. The television and the radio are common examples of such media devices, providing consumers with access to television channels and radio channels, respectively. Similarly, set-top boxes may provide access to satellite channels or IP-TV content, digital video recorders to recorded video content and e-readers to electronic books. Many of these devices nowadays also provide access to internet content.

Many of these media devices are equipped with a means of access control that allows consumers to control the access to the media content. For example, some television channels or programs may be inappropriate for younger viewers. Hence, the media device may be equipped with a function that identifies the age-appropriateness of the television channel or program, and automatically blocks access to content that is only appropriate to adults. The media device may further allow adults to use the same function to unblock said channel or program after providing a valid authentication.

It is also desirable for a party other than the consumer to control the consumer's access to media content.

For example, a hotel proprietor may wish to only allow access to premium video content on the room's TV if the guest agrees to pay an access fee. A known approach for providing such controlled access is that the room's TV is arranged for automatically billing the access fee to the guest's hotel bill if the guest chooses to watch the premium video content. A drawback of this approach, however, is the hotel needs to be equipped with a network that allows the room's TV to contact a server that administers the guest's hotel bill. This may be technically infeasible in certain situations or costly to realize.

US 2009/0119698 describes an activation token and a remote control that allow a hotel proprietor or other party to control the guest's access to a block of premium channels on the room's TV. The guest can acquire the activation token, which carries with it the right to activate the premium channels on his room's TV during a predetermined time. The activation token can be placed in the remote control to transfer the token's authorization right to the remote control, after which the remote control deactivates the token to prevent usage in another remote control. The remote control can then be used to access the premium channels on the room's TV during the predetermined time period. Thus, the hotel does need to be equipped with a network that allows the room's TV to contact a server.

A problem of US 2009/0119698, however, is that the activation token is not specifically coupled to a particular TV. Thus, the activation token may be cloned prior to usage, and its clones may be used to gain access to the premium channels of multiple TV's. Consequently, the activation token may be counterfeited, and access may be gained to the premium channels of multiple TV's while only paying for access to the premium channels of one TV. A further problem is that the authentication token is a physical object, thus requiring the authentication token to be physically transported to the location of the TV. Moreover, the authentication token has to be manufactured, and thus has non-negligible cost price.

### OBJECT OF THE INVENTION

It is an object of the invention to control a user's access to media content, with the access being granted specifically on a selected media device.

### SUMMARY OF THE INVENTION

In a first aspect of the invention, this object is realized in that a media device is provided for controlling access of a user to media content, the media device comprising an identification code output arranged for providing an identification code to the user, the identification code identifying the media device, a control code generator arranged for generating a control code in dependence on the identification code and an access right, an access code input arranged for receiving an access code from the user, the access code having been generated in dependence on the identification code and the access right, and an access controller arranged for comparing the access code to the control code, and when the access code matches the control code, granting the user access to the media content in accordance with the access right.

The abovementioned aspect of the invention enables controlling a user's access to media content, with access being granted specifically on a selected media device.

For that purpose, the media device provides the identification code to the user that sufficiently distinguishes the particular media device from others. The media device further generates the control code from the identification code and the access right, with the access right specifying certain allowances or limitations of the user's access to the media content. The control code is thus indicative of the allowances or limitations of the user's access to the media content as controlled by the particular media device.

The media device is further arranged for receiving an access code from the user and for comparing the access code to the control code. By comparing both codes, the media device can determine whether the access code was generated using the identification code of the particular media device and using the same access right that was used for generating the control code. If the access code matches the control code, the access code is deemed valid for the particular media device and for the particular access right. The user is thus granted access to the media content in accordance with the access right.

However, if the access code was generated using an identification code of another media device, the access code will not match the control code of the particular media device. The access code is thus deemed invalid, and the media device will not grant the user access to the media content. Consequently, the access code is coupled to a particular media device, and access to the media content is granted specifically on said media device. Counterfeiting the access code for usage on another media device is thus ineffective.

In an embodiment, a media device is provided wherein the control code generator is arranged for generating a plurality of control codes, each of the plurality of control codes being generated in dependence on the identification code and a respective one of a plurality of access rights, and the access controller being arranged for comparing the access code to the plurality of control codes, and when the access code matches one of the plurality of control codes, granting the user access to the media content in accordance with a corresponding one of the plurality of access rights.

The media device will thus deem a plurality of access codes to be valid, provided that the access code was generated in dependence on the identification code and a respective one of a plurality of access rights. If the access code matches any of the control codes, the user is granted access to the media content in accordance with the corresponding access right. As such, the access code not only determines whether or not the user is granted access, but also selects a specific access right amongst a plurality of access rights.

In an embodiment, the access right comprises a content identifier identifying a portion of the media content, and wherein the access controller is arranged for, when the access code matches the control code, granting the user access to the portion of the media content identified by the content identifier.

The access code determines that the user should be granted access to a specific portion of the media content. Consequently, it is possible to only grant access to a portion of the media content instead of to the entire media content, without this having to be additionally specified to the media device.

In an embodiment, the access right comprises an access period, and wherein the access controller is arranged for, when the access code matches the control code, granting the user access to the media content during the access period.

The access code determines that the user should be granted access to the media content during a specific period. Consequently, a limit can be imposed on the time that the user is granted access without it having to be additionally specified to the media device. In an embodiment, the access period comprises at least one of: a start time, a start date, an end time, an end date or a duration.

The access period may be specified in the form of a particular time or a particular day and in the form of a start or an end of the period. Also, the access period may be specified as a duration, i.e. specified by its length rather than by its start or end. As such, the access period can be specified in various ways and is not limited to a single form.

In an embodiment, the access controller comprises a timer arranged for determining an end of the access period, and the access controller is arranged for denying the user access to the media content after the end of the access period. A timer allows the access controller to determine when the access period ends, thus allowing the access controller to deny the user access after the end of said period.

In an embodiment, the control code generator is arranged for generating the control code by using a hash function with the identification code as a first portion of a key and the access right as a second portion of the key.

A hash function converts a key into a hash value using a mathematical function. However, having obtained a hash value, converting the hash value into the original key is relatively difficult if the hash function is not known. Thus, a hash function offers cryptographic benefits, as the hash value obscures the corresponding key. For certain hash functions, the hash value may also be smaller in size than the key, thus offering the benefit of compression. The identification code and the access right are combined into a key, and the key is mapped by the hash function to a hash value. The control code is thus a hash value.

In an embodiment, the identification code output is arranged for generating the identification code in dependence on a media device dependent parameter and a current time and/or a current date.

The media device dependent parameter allows the media device to be sufficiently distinguished from other media devices. Since both the access code and the control code are generated in dependence on the identification code, the access code thus can only be used with the particular media device. The current time or the current date allow the identification code to be distinguished from previous or future generated identification codes. This may allow the media device to identify whether an access code was previously used, and thus prevent access codes being re-used on the particular media device.

In an embodiment, the media device comprises a television tuner for receiving television channels and a display for displaying the television channels, and the media device controls the access of the user to at least a portion of the television channels.

Television channels are typically offered for free or require a subscription or access fee, i.e. the so-termed premium channels. It is therefore desirable to control the user's access to the premium channels in media devices such as televisions.

In an embodiment, the identification code output is arranged for displaying the identification code on the display, and the access code input is arranged for receiving the access code from the user by way of a remote control.

A convenient way of providing the identification code to the user is displaying said code on the display that is also used for displaying the television channels, since displays provide good readability of text. The display is thus used as the identification code output, lowering the complexity of the media device. Furthermore, a particularly convenient way for the user to provide the access code is by way of the remote control that the user already uses to control the media device. Consequently, the user may simply use the remote control instead of having to handle the media device directly.

In a further aspect of the invention, a system is provided for controlling access of a user to media content, the system comprising the aforementioned media device and an access code device for generating the access code, the access code device comprising an identification code input arranged for receiving the identification code, an access code generator arranged for generating the access code in dependence on the identification code and the access right, and an access code output arranged for providing the access code.

The access code device allows the user to generate an access code for a particular media device. The access code device may be a computer executing a suitable computer program product, or a handheld device comprising a screen and a keypad. However, various other embodiments are equally possible. The access code device receives the identification code of the media device, e.g. by receiving an infrared signal or by having the user enter the access code on a keypad. Upon receiving the identification code, the access code device generates the access code in dependence on the identification code and the access right, and provides the access code to e.g. the user or to the media device. The access right may comprise e.g. an access period or a content identifier. Thus, an access code may be generated that matches the control code of the particular media device, allowing the user to be granted access to the media content controlled by said media device.

In an embodiment, the control code generator of the media device is arranged for generating the control code by using a hash function, and the access code generator of the access code device is arranged for generating the access code by using the same hash function.

The access code generated by the access code device is a hash value. It is therefore relatively difficult to modify the access code in order to modify the identification code or the access right, since both are obscured in the hash value. As such, the risk of forgery of the access code is reduced. Furthermore, the hash value may be smaller in size than the identification code combined with the access right, making the access code relatively easy to handle by e.g. the user. The media device checks the validity of the access code by generating the control code using the same hash function, and comparing the control code to the access code. If both codes match, the access code is deemed valid by the media device.

The user is then granted access to the media content in accordance with the corresponding access right. The access right is known to the media device, even though the access right is obscured in both the control code and the access code. The reason for this is that the control code is generated within the media device. Consequently, the media device knows which access right corresponds to the control code, and therefore can grant access to the media content in accordance with the corresponding access right.

In a further aspect of the invention, a method of controlling access of a user to media content is provided, the method comprising a media device performing the steps of providing an identification code to the user, the identification code identifying the media device, generating a control code in dependence on the identification code and an access right, receiving an access code from the user, the access code having been generated in dependence on the identification code and the access right, and comparing the access code to the control code, and when the access code matches the control code, granting the user access to the media content in accordance with the access right.

In an embodiment, the aforementioned method is provided, with the method further comprising an access code device performing the steps of receiving the identification code, generating the access code in dependence on the identification code and the access right, and providing the access code.

### BRIEF DESCRIPTION OF THE DRAWINGS

These and other aspects of the invention are apparent from and will be elucidated with reference to the embodiments described hereinafter. In the drawings,

FIG. 1 shows a television for controlling access of a user to video content;

FIG. 2 shows a media device for controlling access of a user to media content;

FIG. 3 shows an access code device for generating an access code;

FIG. 4 shows a computer executing a computer program product for generating the access code;

FIG. 5 shows a method of controlling access of a user to media content;

FIG. 6 shows a method of controlling access of a user to media content and of generating the access code.

### DETAILED DESCRIPTION OF EMBODIMENTS

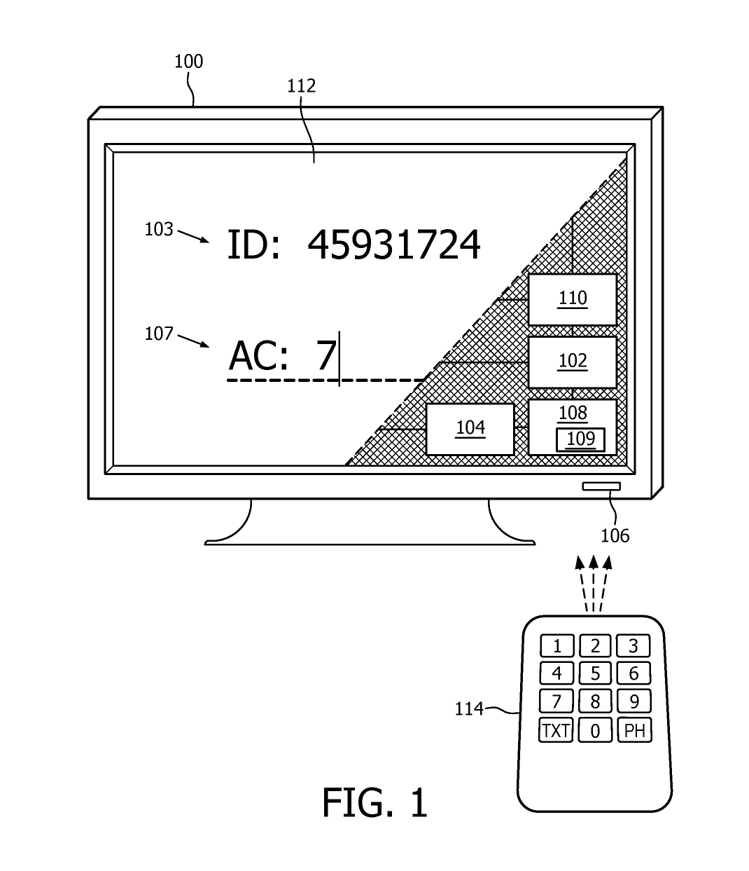

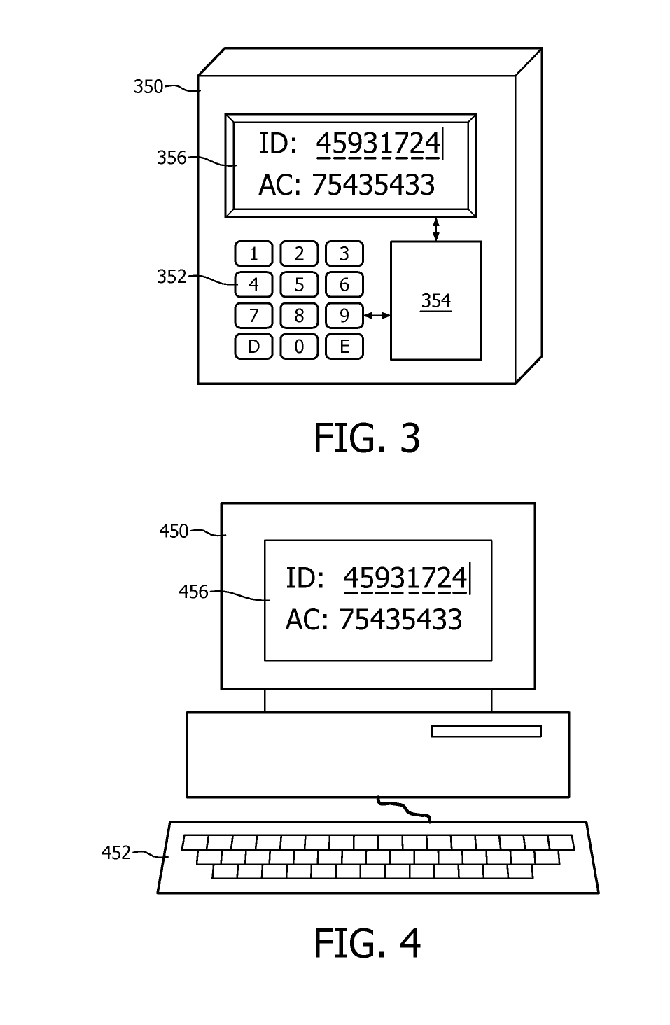

FIG. 1 shows a television 100 that is arranged for controlling access of a user to a portion of the video content provided by the television 100. Essentially, the television 100 generates a control code in dependence on an identification code and an access right. The identification code distinguishes the particular television from others, and the access right describes the nature of the user's access. The identification code is also provided to the user, who may, using the identification code, obtain an access code from e.g. the access code device of FIG. 3 or 4 and provide the access code to the television 100. The television 100 then compares the access code with the control code, and if both match, grants the user access to the portion of the video content in accordance with the access right.

More specifically, the television 100 is arranged as follows. The video content is provided by the television 100 by means of a television tuner 110. The television tuner 110 is typically an internal component of the television 100, and is shown in FIG. 1 through a transparently depicted part of the television 100. The television tuner 110 may be any suitable tuner, such as analog PAL or NTSC tuner or a digital ATSC or DVB tuner. The television tuner 110 may be arranged for receiving the video content via cable, terrestrial or satellite transmission. Also, the video content may also be provided by the television 100 via a network interface that enables an internet protocol television (IP-TV) connection.

The television 100 is arranged for controlling access to at least a portion of the video content. In case the video content comprises multiple television channels, the television 100 may control access to a subset of the television channels. The subset may consist of so-termed premium channels, i.e. television channels that typically require a subscription or payment of a fee to gain access. The video content may also comprise so-termed video-on-demand programs, i.e. video programs that may be selected and watched on demand by the user. In this case, the portion may be a subset of the available video programs. Also, the television 100 may be arranged for controlling access to all available video content.

The television 100 comprises an identification code output 102 that is arranged for providing an identification code that sufficiently distinguishes the particular television from others. The identification code may comprise the serial number of the television or a part of the serial number. In case the television 100 is used as a hotel television, i.e. placed in a hotel guest's room, the identification code may also comprise the room number. The identification code may also be based on the current time, the current date or a pseudo-random number. As such, the identification code not only distinguishes the particular television from others, but also distinguishes itself from other identification codes that have been previously provided by the particular television.

The identification code output 102 is arranged for displaying the identification code on the display 112 of the television 100 in the form of a text-based representation of the identification code 103. For this purpose, the identification code output 102 may comprise a display driver that can display text on the display 112. The identification code output 102 may also be combined with existing functionality of the television that allows text to be displayed on the display 112. For example, the television 100 may comprise a graphical processing unit, which may be used to display the identification code on the display 112. Similarly, if the television 100 is arranged for displaying an electronic programming guide, the same functionally may be used for displaying the identification code.

The television 100 may also comprise an emitter that, instead of displaying the identification code on the display 112, emits said code. The emitter may emit the code in any suitable manner, e.g. by emitting an infrared or radio-frequency signal or as part of a Bluetooth communication. The user may then obtain the identification code by using a receiving device that is suitable for receiving the identification code. The receiving device may be an access code device as is shown in FIG. 3 or 4.

The television 100 further comprises a control code generator 104 that is arranged for generating a control code in dependence on the identification code and an access right. The access right specifies certain allowances or limitations of the user's access to the video content. For example, the access right may comprise an access period that indicates during which period the user is granted access to the video content. The access period may be specified as a time or as a date, e.g. from the 12 ^{th} of April until the 14^{th} of April, or from 6:00 (6 AM) to 18:00 (6 PM). A combination of both is equally possible. The access period may also be specified solely as an end time and date, e.g. ending on the 14^{th} of April at 18:00. The access period may also be specified as a duration, e.g. three days, indicating that the user is granted access to the video content during a period of three days.

The access right may also comprise a content identifier that identifies a portion of the video content to which the user is granted access. For example, the content identifier may identify a group of television channels, or a group of video programs. The portion of the video content identified by the content identifier may be the same portion as the portion to which access is controlled. However, the content identifier may also identify a subset of that portion. For example, the television 100 may be arranged for controlling access to premium channels. The content identifier may then be used to identify the sport-themed television channels amongst the premium channels.

The access right may also comprise a quality identifier that identifies a quality level of the video content to which the user is granted access. For example, the quality identifier may identify a spatial resolution of the video content. As such, the quality identifier may identify whether the user is granted access to the video content in standard definition (SD), having a relatively low resolution of e.g. 720 horizontal by 480 vertical pixels, or to video content in high definition (HD), having a relatively high resolution of e.g. 1920 horizontal by 1080 vertical pixels. Similarly, the quality identifier may identify whether the user is granted access to the video content obtained from an analog source, having typically a relatively low quality, or from a digital source, having typically a relatively high quality.

The control code generator 104 may also be arranged for generating multiple control codes. Each of the control codes may be generated in dependence on the identification code and a unique access rights. For example, the control code generator 104 may generate three control codes, with the first of the control codes being generated in dependence on the identification code and an access period of one day, the second control code being generated in dependence on the identification code and an access period of three days, and the third control code being generated in dependence on the identification code and an access period of five days.

Similarly, the control code generator 104 may generate a first control code in dependence on the identification code and a content identifier identifying sports programs, and a second control code in dependence on the identification code and a content identifier identifying children programs. Of course, various combinations of access periods and content identifiers are equally possible.

The control code generator 104 may generate the control code by combining a data representation of the identification code with a data representation of an access right. For example, the identification code may be expressed as three numbers, e.g. 469. In case the access right is a duration in days, the access right may be simply represented by a single number, e.g. 3 for three days. Both data representations may then be concatenated to form a control code, e.g. 4693. The identification code and thus the control code may also be an alphabetical code, an alphanumerical code, or take any other suitable form.

The control code may also be generated using a mathematical function. For example, a hash function may be used, in which the identification code and the access right are combined into a single key. The hash function then generates a hash value from the single key. A wide variety of hash functions from the fields of mathematics and cryptography may be used. However, it should be noted that many hash functions may map two or more keys to the same hash value, resulting in a so-termed collision. In the selection or design of the hash function, the amount of collisions can be determined. As will also be explained later on, it is generally desirable to keep the number of collisions relatively low, but it is not needed to design the hash function such that no collisions occur.

The television 100 further comprises an access code input 106 that is arranged for receiving an access code from the user by way of a remote control 114. The access code input may receive the access code as a single code, but may also receive the access code in parts, e.g. by firstly receiving the first digit of the access code, secondly the second digit of the access code, etc. For that purpose, the access code input 106 may be arranged as an infrared or radio frequency receiver to receive infrared or radio frequency signals from the remote control 114. The user may thus enter the access code on the keypad of the remote control 114, and the access code input 106 receives the access code in the form of infrared or radio frequency signals generated by the remote control 114. Of course, any other form of communication between the television 100 and the remote control 114 may be used as well. For example, the remote control 114 may communicate with the television 100 via wireless standards such as Bluetooth or ZigBee.

The access code input 106 may also be arranged for receiving the access code from a transmission device other than the remote control 114. For example, the aforementioned receiving device may be arranged for also transmitting the access code to the television 100. Thus, the user may use said device for receiving the identification code from the television 100, and for transmitting the access code to the television 100. Said device may be an access code device as is shown in FIGS. 3 and 4.

The access code input 106 may be further arranged for displaying the user's input on the display 112 of the television 100 in the form of a text-based representation of the access code 107. This may provide visual feedback to the user and reduce the chance of the user entering the access code erroneously. For this, the same functionality as for displaying the text-based representation of the identification code 103 may be used.

The television 100 further comprises an access controller 108 that is arranged for comparing the access code to the control code. If the access code matches the control code, the user is granted access to the portion of the video content in accordance with the access right. The access controller 108 does not need to obtain the access right from the access code or the control code. In fact, this may not be possible if the access code and the control code are hash values that were generated using a hash function, since hash functions are not always reversible. In particular, if a hash function was used that results in the aforementioned collisions, the hash value is not uniquely linked to a particular combination of identification code and access right.

Thus, the access controller 108 may be arranged for obtaining the access right that corresponds to the control code from the control code generator 104. The access controller 108 then grants access in accordance to the corresponding access right. In practice, this means that if the hash function results in collisions, there may be a chance that the user is granted access using an access code that was generated in dependence on an identification code that does not correspond to the particular media device. However, if the chance of collisions is relatively low, the chance of the user gaining access with an invalid access code is also relatively low. Most importantly, a correctly generated access code will always result in the user being granted access.

The access controller 108 further comprises a timer 109 for determining an end of the access period. Depending on the format of the access period, the timer 109 may be implemented in various ways. For example, if the access period comprises an end date, the timer 109 may comprise a calendar that determines when the current date passes the end date. Similarly, if the access period comprises an end time, the timer 109 may comprise a clock that determines when the current time passes the end time. The timer 109 may also be arranged for obtaining the current time or current date from an external source, for example from an electronic program guide or so-termed teletext signal.

Furthermore, if the access period comprises a duration, the timer 109 may be arranged for counting down the time since the user was granted access. Similarly, the timer 109 may be arranged for, based on the duration and the current time and/or date, calculating an end time and/or end date. Of course, combinations of the above are possible as well. The access controller 108 is further arranged for, when the timer indicates 109 that the access period has ended, denying the user access to the media content. More generally, the access controller 108 only grants the user access to the media content during the access period, and denies the user access to the media content outside of the access period.

It should be noted that FIG. 1 shows the television tuner 110, the identification code input 102, the control code generator 104 and the access controller 108 to be connected through a bus system. This means that although the identification code input 102 is not shown to be directly connected to the control code generator 104, the control code generator 104 is able to obtain the identification code from the identification code input 102 through the bus system. Similarly, the access controller 108 can control the access to the video content provided by the television tuner 110 through the bus system. However, the relevant components may also be connected directly to each other without the use of a bus system.

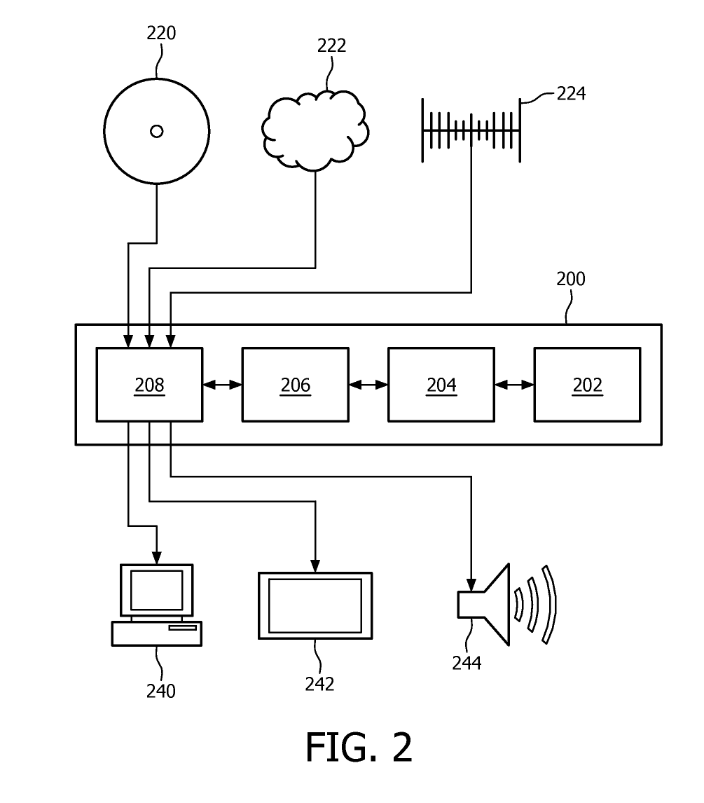

FIG. 2 shows a media device 200 that is arranged for controlling access of a user to media content. The media content may be any suitable media content such as television channels, video programs, radio channels, audio programs, internet content or written content. Such content may be obtained from a wide range of sources. The media device 200 is shown in FIG. 2 to obtain the media content from an optical storage medium 220, the internet 222 and from broadcast 224. The media device may be equipped with a corresponding receiver, e.g. a television tuner or an optical storage reader, but may also be connected to an external receiver, and thus receive the media content from the external receiver using e.g. a video or an audio input.

The media device 200 is shown to be connected to a computer 240, a display 242 and a loudspeaker 244 which may be used by the user to access the media content. Of course, other devices exist as well for allowing the user to access the media content. For example, written content may be accessed using an e-reader. Typically, however, the media device 200 is located in between only one of the sources 220, 222, 224 of media content and one of the devices 240, 242, 244 that the user uses to access said media content. Effectively, the media device acts as a gatekeeper to said media content. The media device 200 may also be integrated with one of the devices 240, 242, 244 that the user uses to access the media content, as for example the television 100 shown in FIG. 1.

The media device 200 comprises an identification code output 202 that is arranged for providing an identification code that sufficiently distinguishes the particular media device from others. The identification code output 202 may take a wide variety of forms. For example, the identification code output may be a display that displays the identification code. The identification code may also be provided to the user by means of a synthetic voice through a speaker. In general, the identification code may be provided in a manner that suits the media content; e.g. visually in case of video content, auditive in case of audio content, etc. The identification code itself may be generated in a similar manner as the identification code generated by the television 100 shown in FIG. 1.

Furthermore, the media device 200 comprises an access code input 206 that is arranged for receiving an access code from the user. The access code input 206 may take a wide variety of forms. For example, the access code input 206 may comprise a keypad that the user can use to enter the access code. The access code input 206 may also be arranged as a Bluetooth receiver that receives the access code via Bluetooth from a remote control. The access code input 206 may also be arranged for recognizing speech, thus enabling the user to provide the access code to the media device 200 by speaking said code out loud. In general, the access code input 206 may take any form that allows the user to provide the access code to the media device 200 in a reasonably convenient manner.

Lastly, the media device 200 comprises a control code generator 204 and an access controller 208, both being similar to the control code generator 104 and the access controller 108 of the television 100 shown in FIG. 1, respectively.

FIG. 3 shows an access code device 350 for generating an access code. The access code device 350 comprises an identification code input 352 in the form of a keypad that is arranged for receiving the identification code from the user. The user may thus enter the identification code by typing the code on the keypad. The identification code input 352 may also be arranged for receiving the identification code directly from the television 100 or media device 200. For example, the identification code input 352 may comprise an infrared or radio-frequency receiver or a Bluetooth receiver, with the television 100 or media device 200 comprising the corresponding transmitter. The identification code input 352 may also be arranged for receiving the identification code from the user by means of speech recognition. The user may thus verbally provide the identification code to the access code device 350. The access code device 350 further comprises an access code generator 354 arranged for generating the access code in dependence on the identification code and an access right. The access code generator 354 essentially corresponds to the control code generator 104, 204 of the television 100 or the media device 200. Thus, the access code generator 354 may generate the access code in various ways, e.g. using a hash function.

The access code generator 354 may generate the access code using a fixed access right. More typical, however, is that the access code generator 354 is arranged for selecting a particular access right out of a plurality of access rights, and generating the access code in dependence on the particular access right. The user may also be able to personally select the particular access right. For example, the user may have to pay a fee to obtain an access code from the access code device. The fee may relate to an aspect of the access right, for example the length of the access period. The user may then choose the length of the access period, e.g. by selecting the length using the keypad, and pay a fee that corresponds to said length. After payment, the access code generator 354 then generates the access code in dependence on the particular access period.

Lastly, the access code device comprises an access code output 356, e.g. in the form of a display that is arranged for providing the access code to the user. The access code that was generated by the access code generator 354 is thus displayed on the display. The display 356 may also be used to display the identification code while the user enters said code. This may provide visual feedback to the user, and reduces the chance of the user entering the access code erroneously.

The access code output 356 may also be arranged for transmitting the access code directly to the television 100 or media device 200. For example, the access code output 356 may comprise an infrared or radio-frequency transmitter or a Bluetooth transmitter, with the television 100 or media device 200 comprising the corresponding receiver. The access code output 356 may also be arranged for providing the access code to the user may means of speech. This enables the user to obtain the access code by listening to said code being spoken out loud by the access code device 350.

The television 100 of FIG. 1 or the media device 200 of FIG. 2 may be used together with the access code device 350 in a system that allows a user to obtain access to the media content. The system may be used in a variety of ways. For example, the television 100 of FIG. 1 may be placed in each room of a hotel. Each of the televisions 100 within the hotel is thus arranged to provide an identification code that distinguishes the particular television from the others. Furthermore, each television 100 controls access to a portion of the television channels, i.e. the premium channels. The access code device 350 may be placed in a central location, e.g. the hotel lobby.

A hotel guest can then obtain access to the premium channels by firstly obtaining the identification code of the television 100 in his room. For that purpose, the television 100 may be arranged to display the identification code during a fixed time period after the television is turned on. The television 100 may also be arranged for displaying said code when the user presses a certain key on the remote control 114. The key may be a dedicated key on the remote control 114 that shows a TV menu that also contains instructions for the hotel guest. The TV menu may also contain an entry field for the access code 107.

The hotel guest can obtain the access code using the access code device 350. The hotel guest may have to first pay a fee in order to access said device. This may be incorporated into the access code device 350. Thus, the access code device 350 itself handles the payment by e.g. charging a credit-card that is provided by the guest. Any other suitable form of payment may be used as well. Furthermore, the hotel guest may be able to select between multiple access rights, and then pay a fee corresponding to the selected access right. The access code device 350 then provides the hotel guest with the access code on its display.

Having obtained the access code, the hotel guest can then provide the access code to the television 100 using the remote control 114. For that purpose, the television may display the keys pressed on the remote control 114 on the display 112. The television may also allow the user to erase already entered numbers. Having entered the access code, the user may then select ‘OK’ within the TV menu or use an ‘OK’ key on the remote control to indicate to the television 100 that the access code has been entered. Instead of the user providing the access code, the access code device 350 itself may also be arranged to provide the access code to the television 100 directly. For this purpose, the access code device 350 may comprise e.g. an infrared or radiofrequency transmitter.

After this, the access controller 108 of the television 100 compares the access code to a control code or to a plurality of control codes. If the access code matches the control code or one of the plurality of control codes, the user is granted access to the premium channels. The television 100 may also be arranged for displaying whether or not the access code matches by displaying ‘Accepted’ or ‘Rejected’ on the display.

Consequently, the hotel proprietor can control the access that a hotel guest has to the premium channels on the television in his room, as the hotel guest needs to obtain an access code to access said channels. The access code may be obtained after paying a fee. Since the access code is generated in dependence on the identification code of the particular television, it is ensured that the access code is valid on the particular television, and that other televisions will typically deem the access code not to be valid. Such a system may also be used in other situations in which it is desirable that the access of a user to media content is controlled, such as e.g. in hospitals, cruise ships, resorts, clubs or in public spaces.

Various alternatives exist for the access code device 350 shown in FIG. 3. FIG. 4 depicts one of the alternatives. Here, the access code device is a computer 450. The identification code may be entered using an identification code input in the form of a keyboard 452. The computer runs a computer program product that functions as the access code generator 354 and provides the access code on a computer monitor 456. The computer 450 may be operated by the user or hotel guest directly. The computer 450 may also be operated by a hotel employee, who upon request of the hotel guest, operates the computer 450 to obtain the access code for the hotel guest.

The access code generator may also be implemented as a web-based application instead of a computer program product. Consequently, the user or hotel guest may visit a particular website using the computer 450 and enter the identification code on said website. The website then provides the user or hotel guest with the access code, possibly after first requiring the user to pay a fee. The user or hotel guest may also visit the particular website using a mobile phone, and enter the identification code using the mobile phone. Also, the access code generator may be implemented as a SMS or similar message service. Thus, the user may send a SMS comprising the identification code to said service, and subsequently also receive the access code from said service by SMS.

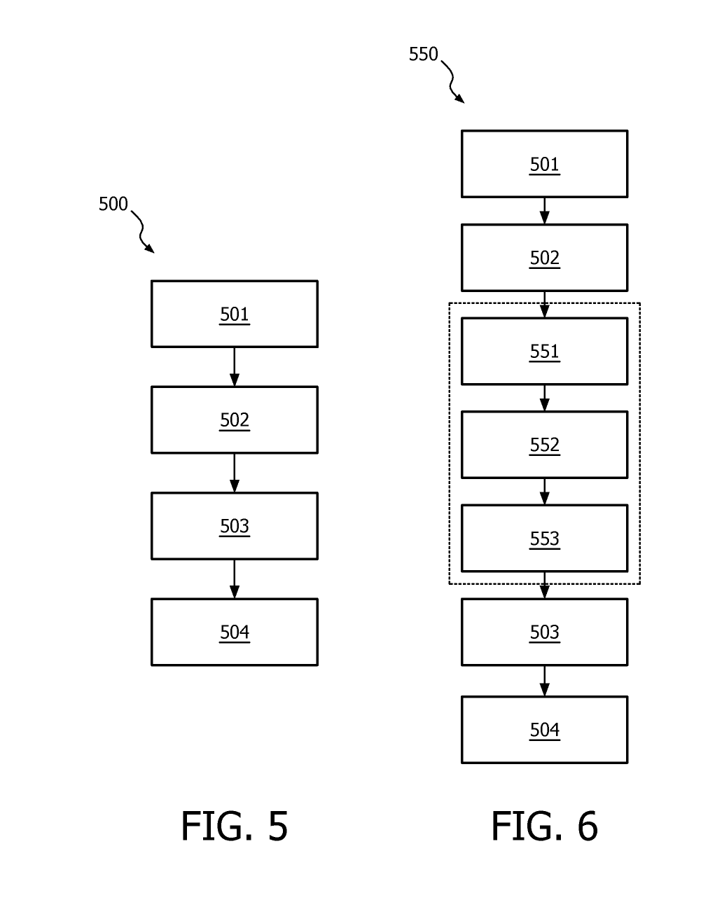

FIG. 5 shows a method 500 of controlling access of a user to media content, the method comprising a media device performing the steps of providing 501 an identification code to the user, the identification code identifying the media device. The method further comprises generating 502 a control code in dependence on the identification code and an access right, and receiving 503 an access code from the user, the access code having been generated in dependence on the identification code and the access right. Lastly, the method comprises comparing 504 the access code to the control code, and when the access code matches the control code, granting the user access to the media content in accordance with the access right.

FIG. 6 shows a method 550 of controlling access of a user to media content. Here, reference numerals that are identical to those of FIG. 5 indicate identical items. Consequently, the method comprises the steps of the method of FIG. 5. In addition, the method comprises an access code device performing the steps of receiving 551 the identification code from the user, the identification code identifying the media device, generating 552 the access code in dependence on the identification code and the access right, and providing 553 the access code to the user.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the media device claim enumerating several means, several of these means may be embodied by one and the same item of hardware. The mere fact that certain measures are recited in mutually different dependent claims does not indicate that a combination of these measures cannot be used to advantage.

1. Media device for controlling access of a user to media content, the media device comprising:
an identification code output arranged for providing an identification code to the user for enabling the user to obtain an access code from an access code device by providing the identification code the access code device, the identification code identifying the media device,
a control code generator arranged for generating a control code in dependence on the identification code and an access right, the access right specifying allowances or limitations of the access of the user to the media content, an access code input arranged for receiving the access code from the user, and
an access controller arranged for determining whether the access code was generated using the identification code and the access right that were used for generating the control code by comparing the access code to the control code, and when the access code matches the control code, granting the user access to the media content in accordance with the access right.

2. Media device according to claim 1, wherein the control code generator is arranged for generating a plurality of control codes, each of the plurality of control codes being generated in dependence on the identification code and a respective one of a plurality of access rights, and the access controller being arranged for comparing the access code to the plurality of control codes, and when the access code matches one of the plurality of control codes, granting the user access to the media content in accordance with a corresponding one of the plurality of access rights.

3. Media device according to claim 1, wherein the access right comprises a content identifier identifying a portion of the media content, and wherein the access controller is arranged for, when the access code matches the control code, granting the user access to the portion of the media content identified by the content identifier.

4. Media device according to claim 1, wherein the access right comprises an access period, and wherein the access controller is arranged for, when the access code matches the control code, granting the user access to the media content during the access period.

5. Media device according to claim 4, wherein the access period comprises at least one of: a start time, a start date, an end time, an end date or a duration.

6. Media device according to claim 4, wherein the access controller (108) comprises a timer arranged for determining an end of the access period, and wherein the access controller is arranged for denying the user access to the media content after the end of the access period.

7. Media device according to claim 1, wherein the control code generator is arranged for generating the control code by using a hash function with the identification code as a first portion of a key and the access right as a second portion of the key.

8. Media device according to claim 1, wherein the identification code output is arranged for generating the identification code in dependence on a media device dependent parameter and a current time and/or a current date.

9. Media device according to claim 1, wherein the media device comprises a television tuner for receiving television channels and a display for displaying the television channels, and wherein the media device controls the access of the user to at least a portion of the television channels.

10. Media device according to claim 9, wherein the identification code output is arranged for displaying the identification code on the display, and wherein the access code input is arranged for receiving the access code from the user by way of a remote control.

11. System for controlling access of a user to media content, the system comprising the media device of claim 1 and the access code device for generating the access code, the access code device comprising:
an identification code input arranged for receiving the identification code,
an access code generator arranged for generating the access code in dependence on the identification code and the access right, and
an access code output arranged for providing the access code.

12. System according to claim 11, wherein the control code generator of the media device is arranged for generating the control code by using a hash function, and wherein the access code generator of the access code device is arranged for generating the access code by using the same hash function.

13. Method of controlling access of a user to media content, the method comprising a media device performing the steps of:
providing an identification code to the user for enabling the user to obtain an access code from an access code device by providing the identification code to the access code device, the identification code identifying the media device,
generating a control code in dependence on the identification code and an access right, the access right specifying allowances or limitations of the access of the user to the media content.
receiving the access code from the user, and
determining whether the access code was generated using the identification code and the access right that were used for generating the control code by comparing the access code to the control code, and when the access code matches the control code, granting the user access to the media content in accordance with the access right.

14. Method according to claim 13, the method further comprising the access code device performing the steps of:
receiving the identification code,
generating the access code in dependence on the identification code and the access right, and
providing the access code.

15. Computer program product comprising instructions for causing a processor system to perform the method of claim 13.
